(19) United States
(12) Patent Application Publication
(10) Pub. No.: US 2008/0148142 A1
(43) Pub. Date: Jun. 19, 2008

(54) SYSTEM AND METHOD FOR INSERTING DATA INTO A PDF DOCUMENT

(75) Inventors: CHUNG-I LEE, Tu-Cheng (TW); HAI-HONG LIN, Shenzhen (CN); DE-YI XIE, Shenzhen (CN); ZHENG-CAI ZHU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/757,402

(22) Filed: Jun. 4, 2007

(30) Foreign Application Priority Data
Dec. 13, 2006 (CN) 200610201282.7

(51) Int. Cl. G06F 17/00; G06F 17/30

(52) U.S. Cl. 715/234; 715/255; 707/1

(57) ABSTRACT

A computer-based method for inserting data into a PDF document is provided. The method includes: generating a template based on contents and elements of the PDF document; reading data to be inserted into the PDF document from a database; processing the read data according to the elements of the PDF document; inserting the data processed into the template; integrating the data inserted template with the PDF document; and generating the data inserted PDF document. A related system is also disclosed.

### BACKGROUND OF THE INVENTION

1. Field of the Invention

The present invention generally relates to a system and method for inserting data into a PDF document.

2. General Background

Along with the release of Adobe Acrobat 7.0, users can inserting data into a PDF (portable document format) document (refers to FIG. 4) like a form by utilizing function of the Adobe design. The PDF document that has text boxes, choice boxes, and push buttons will have a wide application in our daily job.

However, when inserting data into the PDF document, conventional method is that inserting data into the text boxes, the choice boxes or the push buttons of the PDF document manually.

The conventional method is disadvantageous because of the followings:

1. inefficiency: user inserting data into the text boxes, the choice boxes and the push buttons manually is very redundant and exhausting.
2. inaccuracy: human error is unavoidable, so extra resources are needed to double check the data inserted in the PDF document.

### SUMMARY OF THE INVENTION

A system for inserting data into a PDF document is provided. The system includes an application server and a database. The application server includes: a template generating module configured for generating a template based on contents and elements of the PDF document; a data reading module configured for reading data to be inserted into the PDF document from the database; a data processing module configured for processing the read data according to the elements of the PDF document, and inserting the data processed into the template; and a data integrating module configured for integrating the data inserted template with the PDF document.

Another preferred embodiment provides a computer-based method for inserting data into a PDF document. The method includes: generating a template based on contents and elements of the PDF document; reading data to be inserted into the PDF document from a database; processing the read data according to the elements of the PDF document; inserting the data processed into the template; integrating the data inserted template with the PDF document; and generating the data inserted PDF document.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of hardware configuration of a system for inserting data into a PDF document in accordance with a preferred embodiment;

FIG. 2 is a schematic diagram of function modules of an application server of FIG. 1;

FIG. 3 is a flowchart illustrating a method for inserting data into a PDF document in accordance with a preferred embodiment;

FIG. 4 is a schematic diagram of a PDF document;

FIG. 5 is a schematic diagram of a template generated based on the PDF document of FIG. 4, which is not inserted into data; and

FIG. 6 is a schematic diagram of the template of FIG. 5, which is inserted into the data.

### DETAILED DESCRIPTION OF THE INVENTION

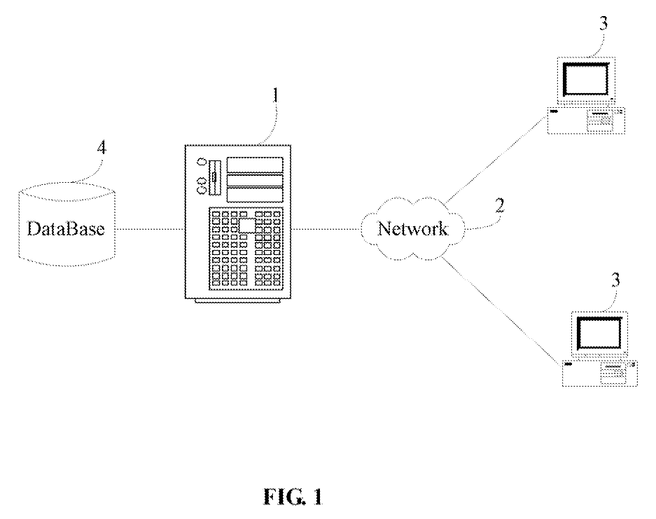

FIG. 1 is a schematic diagram of hardware configuration of a system for inserting data into a PDF document (hereinafter “the system”), in accordance with a preferred embodiment. The system typically includes an application server 1, at least one client computer 3 (two shown) that connects to the application server 1 through a network 2, and a database 4.

The application server 1 includes a plurality of function modules, the function modules are mainly configured for inserting data into the PDF document automatically. The network 2 is an electronic network, which may be the Internet, an intranet, or any other suitable type of communications means.

The client computers 3 may be located at various internal departments of an organization that implements the system, and each client computer 3 provides a user interface. The application server 1 is accessible via any one of the client computers 3.

The database 4 connects to the application server 1 through a connection (not shown), and is configured for storing related data to be inserted into the PDF document, and for storing a template generated while inserting data into the PDF document.

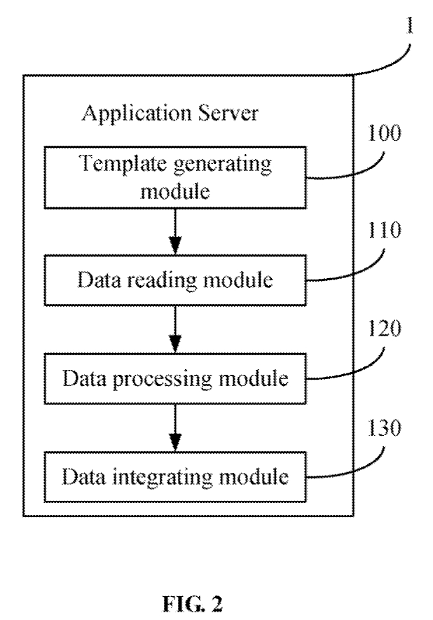

FIG. 2 is a schematic diagram of function modules of the application server 1 of FIG. 1. The application server 1 mainly includes a template generating module 100, a data reading module 110, a data processing module 120, and a data integrating module 130.

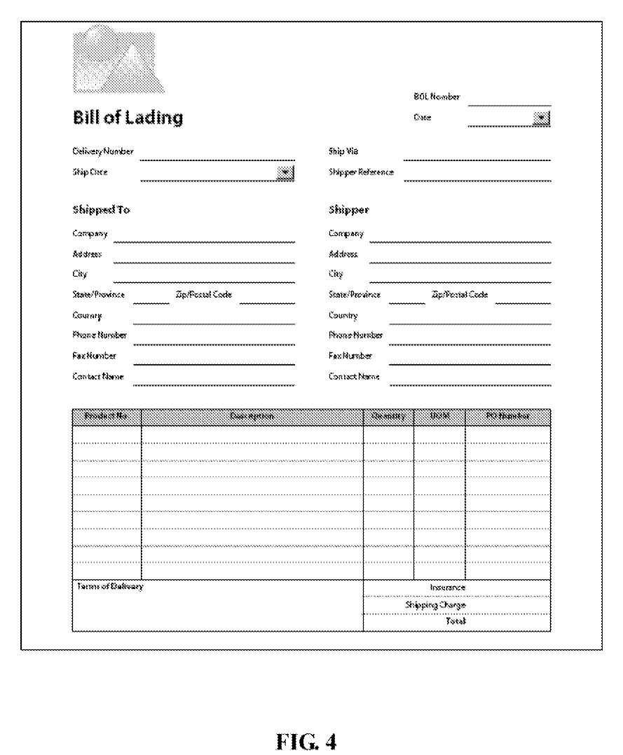

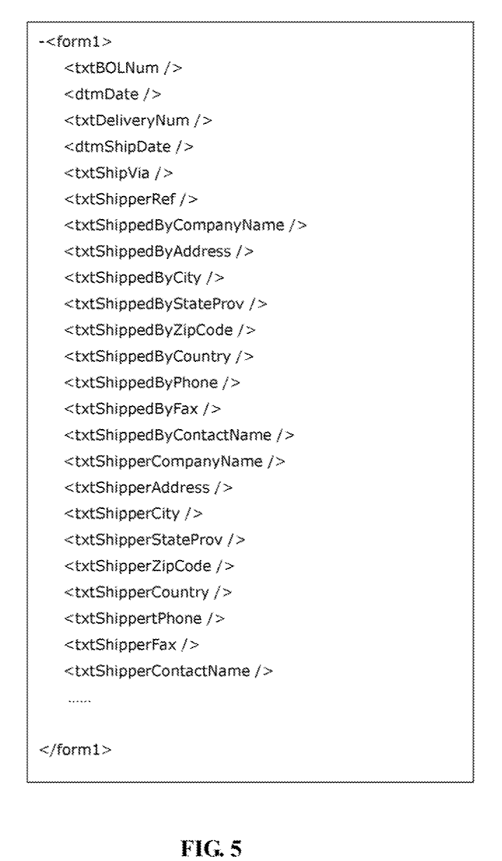

The template generating module 100 is configured for generating a template based on contents and elements of the PDF document (an exemplary PDF document is shown in FIG. 4), and for storing the template into the database 4. The elements of the PDF template may include text boxes, choice boxes, push buttons, and so on. In the preferred embodiment, a format of the template is the XML (extensible markup language) format. An exemplary template refers to FIG. 5. The template in FIG. 5 is generated based on the contents and elements of the PDF document in FIG. 4.

The data reading module 110 is configured for reading data to be inserted into the PDF document from the database 4.

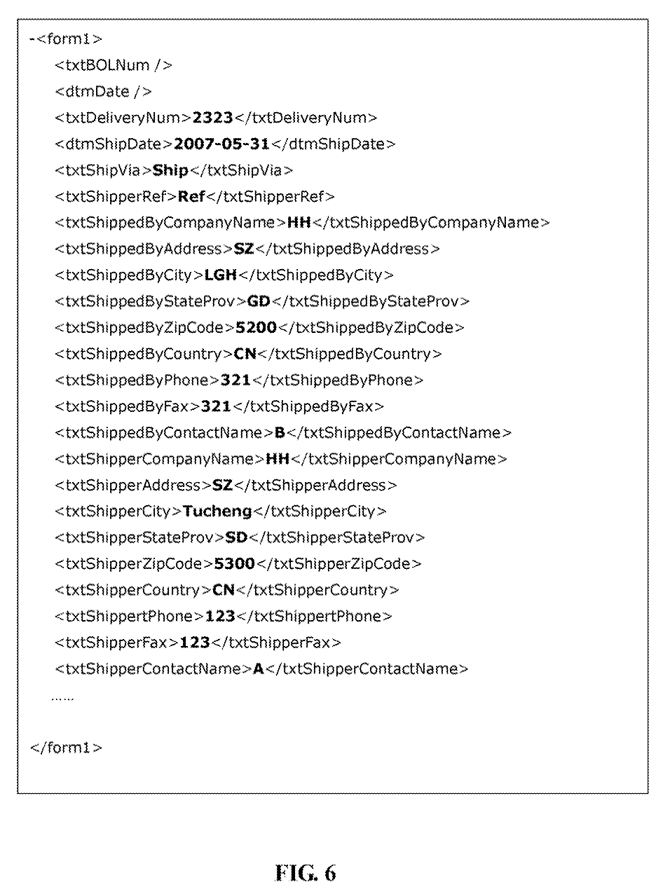

The data processing module 120 is configured for processing the read data according to the elements of the PDF document, and inserting the data processed into the template, thereby yielding the data inserted template. An exemplary data inserted template can be seen in FIG. 6. The data processing may be, for example, transforming time/date format of the read data into a compatible format of the PDF document, such as a “yyyy-mm-dd” format.

The data integrating module 130 is configured for integrating the data inserted template with the PDF document by utilizing an API (application program interface) function.

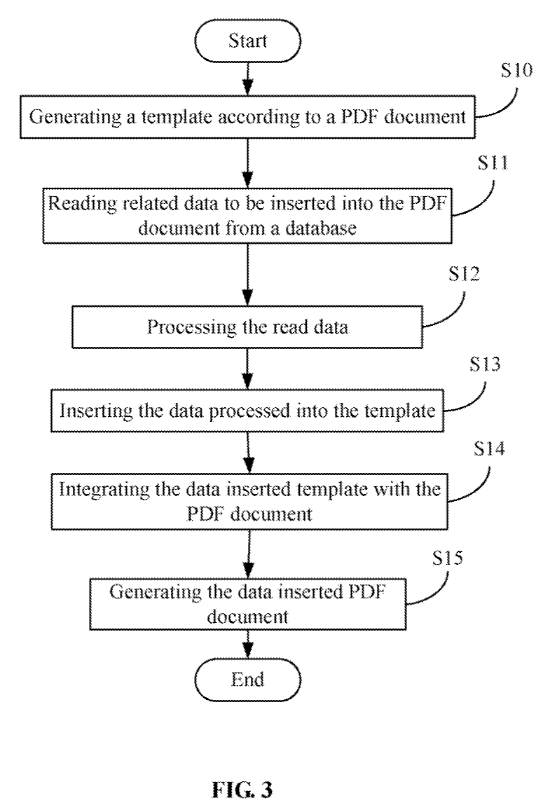

FIG. 3 is a flowchart illustrating a method for inserting data into a PDF document in accordance with a preferred embodiment.

In step S10, the template generating module 100 generates a template according to contents and elements of the PDF document that needs to be inserted with data, and stores the template into the database 4.

In step S11, the data reading module 110 reads data to be inserted into the PDF document from the database 4.

In step S12, the data processing module 120 processes the read data according to the elements of the PDF document. The data processing may be, for example, transforming time/date format of the read data into a compatible format of the PDF document, such as a “yyyy-mm-dd” format.

In step S13, the data processing module 120 inserts the data processed into the template, thereby yielding the data inserted template.

In step S14, the data integrating module 130 integrates the data inserted template with the PDF document by utilizing an API function.

In step S15, the data inserted PDF document is generated.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for inserting data into a PDF document, the system comprising an application server and a database, the application server comprising:
a template generating module configured for generating a template based on contents and elements of the PDF document;
a data reading module configured for reading data to be inserted into the PDF document from the database;
a data processing module configured for processing the read data according to the elements of the PDF document, and inserting the data processed into the template; and
a data integrating module configured for integrating the data inserted template with the PDF document.

2. The system according to claim 1, wherein a format of the template is an XML format.

3. The system according to claim 1, wherein the elements of the PDF document comprise text boxes, choice boxes, and push buttons.

4. The system according to claim 1, wherein the template generating module is further configured for storing the template that is not inserted with data into the database.

5. A computer-based method for inserting data into a PDF document, the method comprising:
generating a template based on contents and elements of the PDF document;
reading data to be inserted into the PDF document from a database;
processing the read data according to the elements of the PDF document;
inserting the data processed into the template;
integrating the data inserted template with the PDF document; and
generating the data inserted PDF document.

6. The method according to claim 5, wherein a format of the template is an XML format.

7. The method according to claim 5, wherein the elements of the PDF document comprise text boxes, choice boxes, and push buttons.

8. The method according to claim 5, further comprising:
storing the template that is not inserted with data into the database.
